(19) United States
(12) Patent Application Publication
(10) Pub. No.: US 2012/0318208 A1
(43) Pub. Date: Dec. 20, 2012

(54) DRAINING FLOOR WITH A BIOLOGICAL REACTOR

(75) Inventor: Torhild Hessevik Eikeland, Farsund (NO)

(73) Assignee: SmartStables AS, Farsund (NO)

(21) Appl. No.: 13/511,332

(22) PCT Filed: Nov. 22, 2010
(86) PCT No.: PCT/NO2010/000426

§ 371 Date: Aug. 7, 2012

(30) Foreign Application Priority Data
Nov. 30, 2009 (NO) 20093440

(51) Int. Cl. A01K 1/01

(52) U.S. Cl. 119/479

(57) ABSTRACT

A draining floor system for a living area (1) for domestic animals is described, in which a floor (14) is provided with a number of drain openings (141), one or more reactors (15), which is/are arranged to bring about aerobic, biological degradation of nutrient-rich waste fluid (4), being arranged in connection with the floor (14) and being arranged to receive the nutrient-rich waste fluid (4) which is drained through the drain openings (141) of the floor (14) and carry a converted fluid (5) away from the living area (1).

A draining floor system for a living area for domestic animals is described, in which a floor is provided with a number of drain openings, further characterized by one or more reactors, which is/are arranged to effect aerobic degradation of a nutrient-rich waste fluid, being arranged in connection with the floor and being arranged to receive the nutrient-rich waste fluid which is drained through the drain openings of the floor and carry a converted fluid away from the living area.

In many industrialized countries the stock of horses has become very big, as the use of horses for recreation and sports increases. Often, this horse husbandry is not connected to agriculture with associated spreading areas for manure, but often takes place in densely populated regions, where stabling may create conflicts because of conditions associated with horse manure, especially in the form of flies and other insects, smell and biological material run-off. To create as good conditions as possible, manure and wet bedding are removed from the stabling site up to several times a day. This is labour-intensive and the mixture of manure and bedding is not very usable as a soil conditioner because of its very high content of slowly convertible materials, that is to say materials with a high C/N ratio.

From other animal husbandry it is generally known to use draining floors, for example slatted floors for cattle. The functionality of such floors is based on all the excrement, liquid as well as solid, passing through openings in the draining floor. This is conditional on the solid manure being either sufficiently soft for it to be squeezed through the openings in the floor, typically the case with cattle and pig manure, or in such small particles that it will pass through the openings, typically the case with small-livestock manure. For horse manure this will be technically difficult, and for amateur horse husbandry a draining floor with a sufficiently large carrying capacity and sufficient openings to work will be economically impracticable.

There is therefore a need to provide a floor system which takes care of the problems mentioned, both technically and economically.

The invention has for its object to remedy or reduce at least one of the drawbacks of the prior art, or at least provide a useful alternative to the prior art.

The object is achieved through features which are specified in the description below and in the claims that follow.

A floor system is provided, which takes care of the horse husbandry's need for living areas with a firm base for horses, there being a draining floor, formed of grids or a perforated plastic material for example, arranged in all or parts of said living area. This floor is arranged to drain urine and other liquid, thereby maintaining a relatively dry floor without the use of any great amounts of moisture-absorbent bedding. The draining floor may appropriately be covered with a mat of a sufficiently soft, but durable material with draining properties. The surface of the draining floor system is adapted for intercepting the solid manure so that, with a suitable tool, it may be scraped away or collected and thereby removed from the living area of the horse. To the draining floor is/are connected one or more reactors arranged to provide aerobic degradation of urine and other nutrient-rich fluid which is drained away from the floor, for example wash water containing manure particles, also called nutrient-rich waste fluid in what follows, as the reactors provide a large area of liquid and also a good supply of air to the liquid surfaces in order thereby to make, by means of bacterial cultures present, the organic content of the nutrient-rich waste fluid be converted so that the converted fluid can be discharged without any risk of pollution. The reactor(s) is/are preferably arranged right below the draining floor as this gives the advantage of the nutrient-rich waste fluid being distributed over the reactor(s) without any particular technical means being used. The converted fluid leaving the reactor(s) may be carried away via a drain system located below the reactor(s), or, if the porosity of the underground and other conditions allow it, the converted fluid may be carried straight down into the underground masses.

The invention relates more specifically to a draining floor system for a living area for domestic animals, in which a floor is provided with a number of drain openings, characterized by one or more reactors, arranged to bring about aerobic biological degradation of nutrient-rich waste fluid, being arranged in connection with the floor and being arranged to receive the waste fluid which is drained through the drain openings of the floor, the reactor including a reactor medium which is formed of a material or a material mixture collected from the group consisting of inert ceramic particles with tight shells enclosing porous cores, fibre materials, and laminate-like materials being arranged to carry converted waste fluid away from the living area, (each of) said reactor(s) being arranged to carry the converted fluid to an adjacent underground mass or to a drain pipe.

The reactor(s) may form a base for a substantial part of the area of the floor, the waste fluid being drainable directly to an arbitrary area of the reactor.

Said reactor/each of said reactors may be provided with a reactor casing which is arranged to carry the converted fluid to the drain pipe. This gives the possibility of building the device according to the invention into existing livestock rooms et cetera as the fluid is carried away via a pipeline network.

The reactor casing may be arranged to support the floor. The reactor casing thereby functions as a supporting structure.

The floor may be completely or partially covered with a draining mat. The floor may thereby be formed of materials which are chosen independently of the consideration of the animals' comfort, as the desired properties that are relevant to the animal's comfort, a carer's wishes regarding cleaning and other maintenance et cetera are taken into consideration when the mat materials are being chosen.

In what follows is described an example of a preferred embodiment which is visualized in the accompanying drawings, in which:

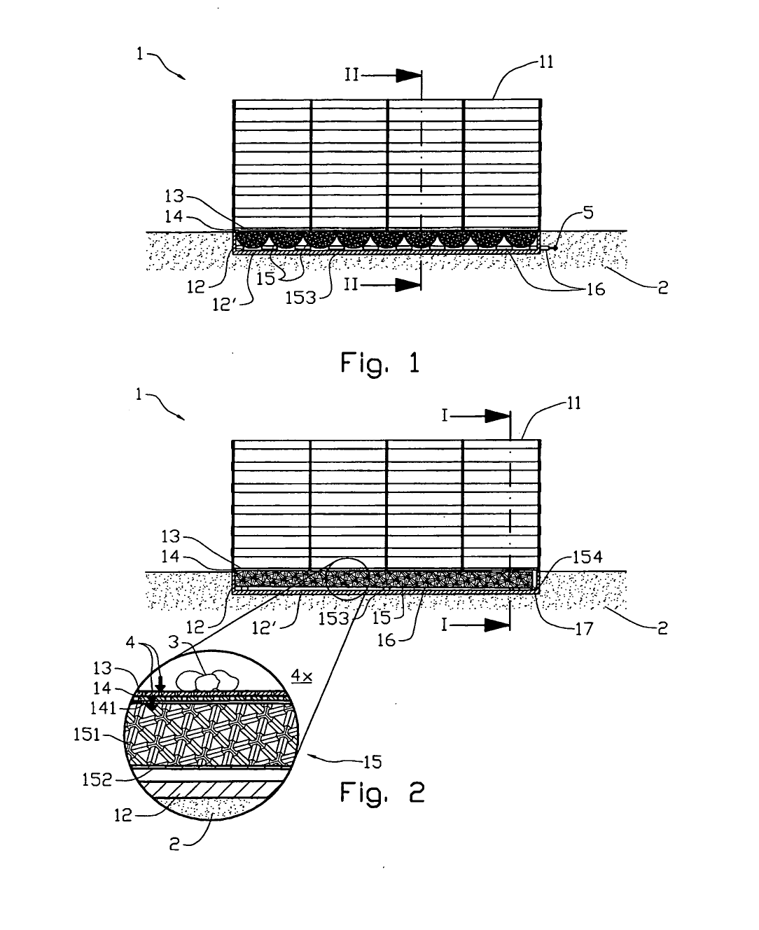

FIG. 1 shows a cross section through a horse stall indicated by I-I in FIG. 2 with a draining floor with a biological reactor according to a first exemplary embodiment of the invention, the converted fluid being carried away through a drain system;

FIG. 2 shows a longitudinal section through the horse stall indicated by II-II in FIG. 1 and, in a section on a larger scale, a detail of a draining floor; and

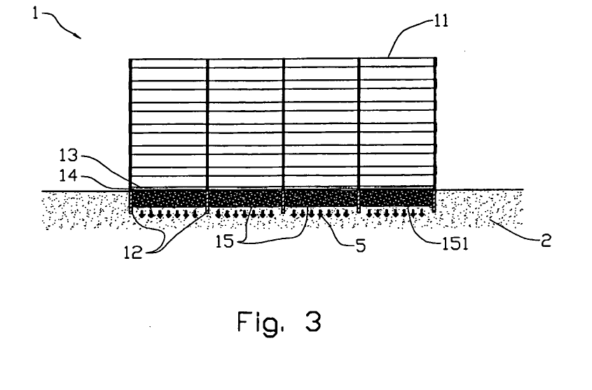

FIG. 3 shows a cross section through a horse stall with a draining floor with a biological reactor according to a second exemplary embodiment of the invention, the converted fluid being infiltrated into the underground.

In the drawings the reference numeral 1 indicates a living area for animals, in particular a horse stall, possibly a so-called box. The horse stall 1 is defined by several side walls 11 which are fixed to and resting on foundations 12.

In a first exemplary embodiment, as it appears from the FIGS. 1 and 2, several reactors 15 are arranged on an original tight floor 12′ in the horse stall 1. The reactors 15 are formed by a trough-shaped reactor casing 152 containing a reactor medium 151 (see the enlarged detail in FIG. 2) providing a large surface and enabling the flow-through of gas, for example atmospheric air. This can be achieved by the reactor medium 151 being formed of a fibre- or laminate-like material. The reactor casing 152 is provided with several supports 154 providing, when the reactor 15 is arranged in a position of use, for the bottom of the reactor casing 152 to exhibit a slope from one end of the reactor 15 to the other end at which an outlet opening 154 is arranged in the reactor casing 152. Via the respective outlet openings 154, the reactors 15 are in fluid communication with a drain pipe 16 which is arranged to carry a fluid away from the reactors 15 and out of the horse stall 1.

The horse stall 1 rests on an underground mass 2.

A floor 14, also called draining floor, arranged with several drain openings 141 constitutes a solid base in the horse stall 1, forming a cover over the reactors 15.

Solid manure is indicated by the reference numeral 3, nutrient-rich waste fluid such as urine, wash water containing manure, et cetera is indicated by the reference numeral 4, and fluid which has passed the reactor 15 and has been converted is indicated by the reference numeral 5.

In a second exemplary embodiment, as it is shown in FIG. 3, the horse stall 1 is not provided with the tight floor 12′. In this example, in addition to supporting the side walls 11, the foundations 12 are arranged to function as a support for the draining floor 14. Between the foundations 12 are arranged reactors 15 by the reactor medium 151 being placed directly on the underground mass 2. The fluid 5 which has passed through the reactor 15 is infiltrated directly into the underground mass 2.

In the second exemplary embodiment, the reactor 15 may be provided with a permeable reactor casing (not shown) which functions primarily as packaging for the reactor medium 151 during transport, possibly with integrated tight border portions (not shown) preventing the nutrient-rich waste fluid 4 from being carried down outside or along the side edge of the reactor 15, thereby being infiltrated into the underground without any conversion worth mentioning.

The reactor medium 151 may be any material or a material mixture that promotes biological degradation of the nutrient-rich waste fluid 4. An example of a suitable material is Filtralite® which is formed of inert ceramic particles with tight shells enclosing porous cores.

The use of the floor system according to the invention reduces the need to use moisture-absorbent bedding in the horse stall 1, as the draining floor 14 provides for the nutrient-rich waste fluid 4 to be carried away. The use of the draining mat 13 on the draining floor 14 simplifies the work of removing the solid manure 3 and makes it possible for the choice of material in the draining floor 14 not to be directed by the consideration of the comfort of the horse but by criteria such as strength, durability, price et cetera. The draining of the nutrient-rich waste fluid 4 and the biological conversion of it in the reactor 15 reduce the odour nuisance and the risk of polluting run-off into the surroundings, and the reduced use of bedding gives less dust nuisance for animals and personnel and results in the solid manure 3 being more usable as a soil conditioner and plant nutrition. The transport volume of the solid manure 3 is also reduced, which has a positive effect on the costs of the horse husbandry.

1. A draining floor system for a living area (1) for domestic animals, in which a floor (14) is provided with a number of drain openings (141), characterized in that one or more reactors (15) which is/are arranged to bring about aerobic biological degradation of nutrient-rich waste fluid (4) is/are arranged in connection with the supporting floor (14) and is/are arranged to receive the nutrient-rich waste fluid (4) which is drained through the drain openings (141) of the floor (14), the reactor (15) including a reactor medium (151) which is formed of any material or a material mixture which promotes biological degradation of a nutrient-rich waste fluid (4) and is arranged to carry converted waste fluid (5) away from the living area (1).

2. The draining floor system according to claim 1, characterized in that the reactor(s) (15) form(s) a base for a substantial part of the area of the draining floor (14), the nutrient-rich waste fluid (4) being drainable directly into an arbitrary area of the reactor (15).

3. The draining floor system according to claim 1, characterized in that (each of) said reactor(s) (15) is/are provided with a reactor casing (152) which is arranged to carry the converted fluid (5) to a drain pipe (16).

4. The draining floor system in accordance with claim 1, characterized in that (each of) said reactor(s) (15) is/are arranged to carry the converted fluid (5) to an adjacent underground mass (2).

5. The draining floor system in accordance with claim 1, characterized in that the reactor casing (152) is arranged to support the floor (14).

6. The draining floor system in accordance with claim 1, characterized in that the reactor medium (151) includes inert ceramic particles with tight shells enclosing porous cores.

7. The draining floor system in accordance with claim 1, characterized in that the floor (14) is completely or partially covered by a draining mat (13).
